(19) United States
(12) Patent Application Publication
(10) Pub. No.: US 2004/0053699 A1
(43) Pub. Date: Mar. 18, 2004

(54) Conversion of gaming machine between reel slots and video game

(76) Inventors: James M. Rasmussen, Chicago, IL (US); Norman R. Wurz, Des Plaines, IL (US)

Correspondence Address: Michael J. Blankstein, WMS Gaming Inc., 800 South Northpoint Boulevard, Waukegan, IL, 60085, US

(21) Appl. No.: 10/242,477

(22) Filed: Sep. 12, 2002

(51) Int. Cl. A63F 13/00; A63F 9/24

(52) U.S. Cl. 463/46; 463/20

(57) ABSTRACT

A method of converting a gaming machine between a machine for conducting a physical reel slot game and a machine for conducting a video game is disclosed. The gaming machine initially contains one of a physical slot reel assembly and a video display mounted to a mounting mechanism inside the machine. In the conversion method, the one of the slot reel assembly and the video display is removed from the gaming machine, and the other of the slot reel assembly and the video display is mounted to the mounting mechanism in its place. The mounting mechanism may, for example, be a display shelf. Other components may be modified according which of the slot reel assembly and the video display is installed in the gaming machine.

### FIELD OF THE INVENTION

The present invention relates generally to gaming machines and, more particularly, to a method of converting a gaming machine between a machine for conducting a physical reel slot game and a machine for conducting a video game.

### BACKGROUND OF THE INVENTION

A gaming machine is operable to conduct a wagering game such as physical reel slots, video slots, poker, keno, bingo, or blackjack. In response to a wager for purchasing a play of the game, the machine generates a random (or pseudo-random) event and displays an outcome of the random event on a primary display device in a form that can be understood by a player. The machine provides an award to the player if the outcome is one of the winning outcomes defined by a pay table. Occasionally, the random event may trigger a bonus game involving lively animations, display illuminations, special effects, and/or player interaction. Depending upon the type of wagering game conducted with the gaming machine, the primary display device for displaying the game outcome may include a physical slot reel assembly or a video display.

On the one hand, if the type of wagering game is a physical reel slot game, the primary display device is a physical slot reel assembly including a plurality of rotatable symbol-bearing reels. The reels are rotated and stopped to place symbols on the reels in visual association with a display panel mounted in front of the reels. The displayed symbols represent the game outcome. The display panel includes windows for viewing the individual physical reels of the slot reel assembly.

On the other hand, if the type of wagering game is a video game such as video slots, poker, keno, bingo, or blackjack, the primary display device is a video display. The video display portrays game elements associated with the video game. The game elements may, for example, include graphical representations of slot reels (i.e., simulated slot reels), playing cards, keno boards, and bingo boards. The displayed game elements represent the game outcome.

Heretofore, some gaming machines have been designed to accept only one type of primary display device (i.e., a slot reel assembly or a video display) and therefore conduct only one type of wagering game (i.e., a physical reel slot game or a video game). It has not be practical or cost-effective to convert such a gaming machine from one used to conduct a physical reel slot game to one used to conduct a video game. Similarly, it has not been practical or cost-effective to convert such a gaming machine from one used to conduct a video game to one used to conduct a physical reel slot game.

Although other gaming machines have been designed to accept different types of primary display devices (i.e., a slot reel assembly or a video display), such machines generally must be outfitted with different mounting mechanisms for mounting the different types of display devices. For example, a first mounting mechanism is used to mount a slot reel assembly, and a second mounting mechanism is used to mount a video display. The utilized mounting mechanism depends upon which of the display devices is mounted inside the machine. The provision of different mounting mechanisms adds to the cost and complexity of manufacture or conversion of such gaming machines.

The above shortcomings limit the manner in which gaming machines in casinos and other gaming establishments may be upgraded to conduct new games. A gaming machine currently used to conduct a physical reel slot game is generally upgraded to another physical reel slot game. Similarly, a gaming machine used to conduct a video game is generally upgraded to another video game. Because wagering games generally have a short life cycle and therefore must be upgraded often, it would be desirable to offer greater flexibility in the manner in which gaming machines may be upgraded and, at the same time, minimize the cost and complexity of the conversion process.

### SUMMARY OF THE INVENTION

A method of converting a gaming machine between a machine for conducting a physical reel slot game and a machine for conducting a video game is disclosed. The gaming machine initially contains one of a physical slot reel assembly and a video display mounted to a mounting mechanism inside the machine. The slot reel assembly includes a plurality of rotatable symbol-bearing reels for displaying an outcome of a physical reel slot game. The video display may, for example, be used to display an outcome of a variety of wagering games, such as video slots, poker, keno, bingo, and blackjack. In the conversion method, the one of the physical slot reel assembly and the video display is removed from the gaming machine, and the other of the slot reel assembly and the video display is mounted to the mounting mechanism in its place. The mounting mechanism may, for example, be a display shelf.

Other components, such as game software, a user interface (e.g., button panel), and one or more display components of a front door of the gaming machine, may be modified according to which of the slot reel assembly and the video display is installed in the gaming machine. The user interface may, for example, require a first button panel with first button configuration when the slot reel assembly is installed in the gaming machine, and a second button panel with second button configuration when the video display is installed in the gaming machine. The display components may, for example, require a display panel with windows for viewing individual physical reels of the slot reel assembly when the slot reel assembly is installed in the gaming machine, and a bezel for encompassing a screen of the video display when the video display is installed in the gaming machine.

### BRIEF DESCRIPTION OF THE DRAWINGS

The foregoing and other advantages of the invention will become apparent upon reading the following detailed description and upon reference to the drawings.

FIG. 1 is an isometric view of a gaming machine for conducting a physical reel slot game.

FIG. 2 is an isometric view of the gaming machine in FIG. 1 without its front doors to reveal an interior of the machine.

FIG. 3 is an isometric view of a physical slot reel assembly.

FIG. 4 is an isometric view of a gaming machine for conducting a video game.

FIG. 5 is an isometric view of the gaming machine in FIG. 4 without its front doors to reveal an interior of the machine.

FIG. 6 is an isometric view of a video display.

FIG. 7 is an isometric view of the gaming machine in FIGS. 1 and 4 without its front doors and after the primary display device (e.g., slot reel assembly or video display) has been removed from an interior of the machine.

FIGS. 8 and 9 are unexploded and exploded isometric views of an upper door adapted for use with the gaming machine in FIG. 1.

FIGS. 10 and 11 are unexploded and exploded isometric views of an upper door adapted for use with the gaming machine in FIG. 4.

FIGS. 12 and 13 are unexploded and exploded isometric views of a lower door adapted for use with the gaming machine in FIG. 1.

FIGS. 14 and 15 are unexploded and exploded isometric views of a lower door adapted for use with the gaming machine in FIG. 4.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

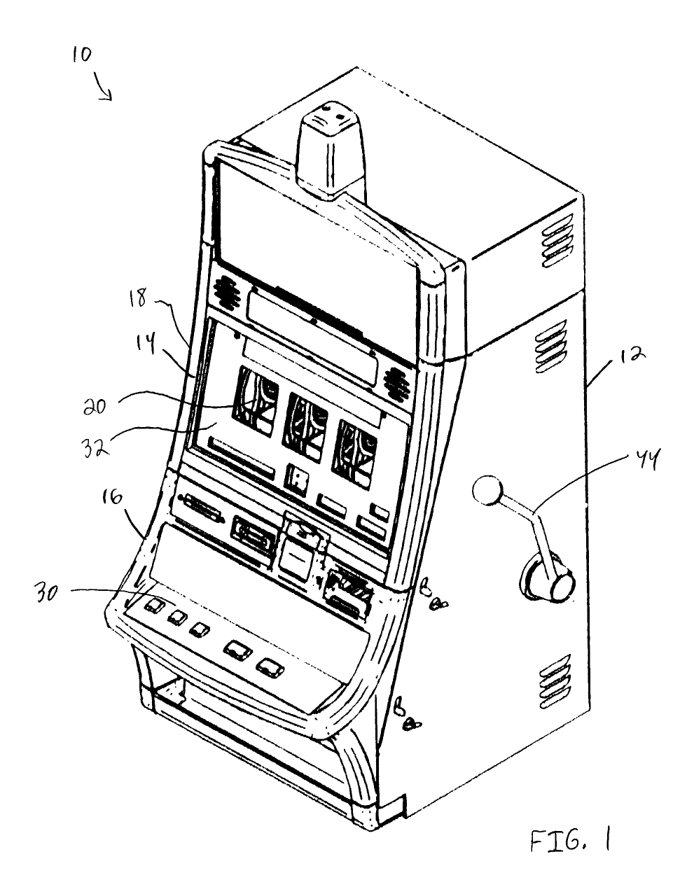

Turning now to the drawings, where like reference numerals are used to identify the same parts, FIG. 1 depicts a gaming machine 10 operable to conduct a physical reel slot game. The machine includes a cabinet 12 and a pair of front doors 14 and 16 hinged to the cabinet 12 along a generally vertical corner 18. In response to a wager for purchasing a play of the reel slot game, the machine generates a random (or pseudo-random) event using a random number generator (RNG) and displays an outcome of the random event on a primary display device. The machine provides an award to the player if the outcome is one of the winning outcomes defined by a pay table. In the case of a physical reel slot game, the primary display device for displaying the game outcome includes a physical slot reel assembly 20. In addition to the primary display device, the machine may include one or more secondary display devices for displaying other game features.

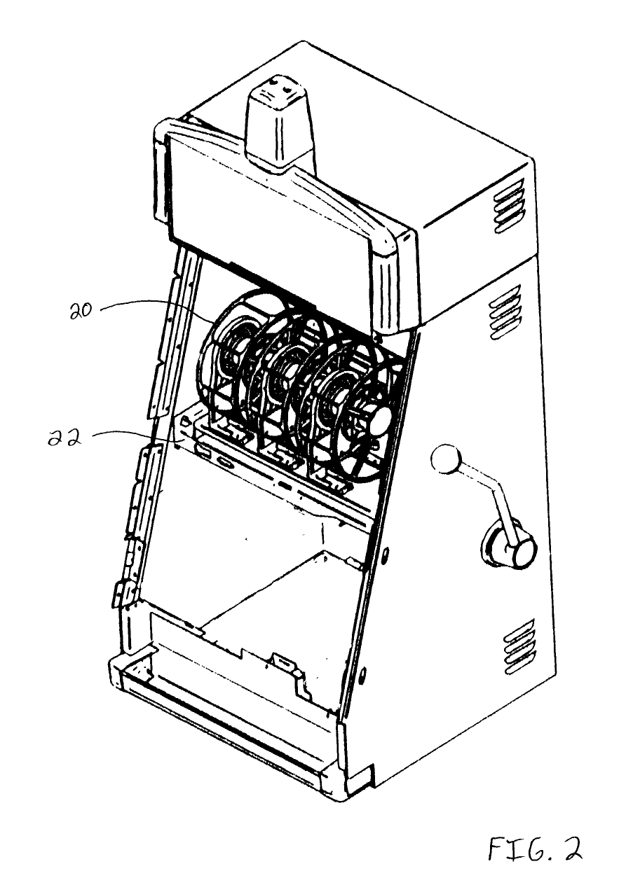

FIG. 2 depicts the gaming machine in FIG. 1 without its front doors to reveal an interior of the machine and, more specifically, the slot reel assembly 20. A display shelf 22 supports the slot reel assembly 20. To prevent the assembly 20 from sliding during normal operation of the machine, the slot reel assembly 20 is detachably engaged to the shelf 22 by screws, bolts, clips, or other fastening mechanisms.

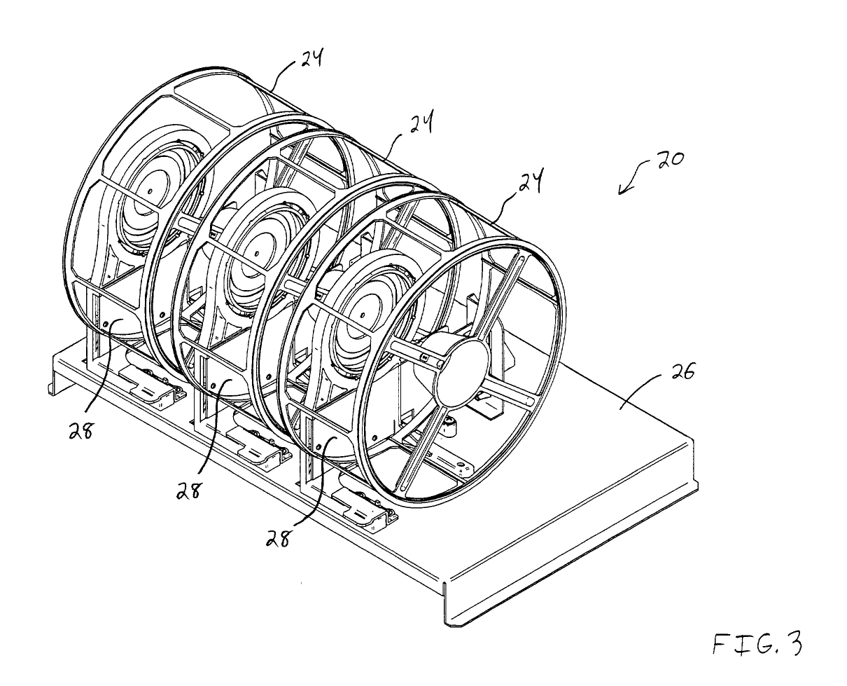

FIG. 3 depicts the slot reel assembly 20. The illustrated slot reel assembly 20 includes a plurality of rotatable symbol-bearing reels 24 mounted to a common frame or tray 26 which, in turn, is mounted to the shelf 22 in FIG. 2. Alternatively, each reel 24 may be mounted to a separate frame which, in turn, is separately mounted to the shelf 22. Although the number of illustrated reels 24 is three, the number of reels 24 may be varied to be more or less than the number illustrated. Symbol-bearing reel strips (not shown) encompass the respective reels 24. The symbols may, for example, include thematic symbols, fruit symbols, or other traditional symbols like 7's, single bar, double bar, triple bar, and bell. The slot reel assembly 20 includes one or more interface boards 28 for controlling movement of the reels 24 based on instructions from a main control unit housed elsewhere in the gaming machine. The interface boards 28 are linked to the main control unit by appropriate electrical wiring.

Referring back to FIG. 1, a player utilizes a user interface 30 (e.g., button panel) to operate the gaming machine. The user interface 30 may include a customized button configuration suitable for playing only a reel slot game, or may alternatively include a generic button configuration suitable for playing either a reel slot game or a video game. The illustrated user interface 30 includes a customized button configuration with five buttons: bet one, max bet, spin reels, collect, and change/call attendant. In response to a wager, the reels of the slot reel assembly 20 are rotated and stopped to randomly place symbols on the reels in visual association with a glass display panel 32 positioned in front of the reels. The display panel 32 includes windows or portals for viewing the individual physical reels of the slot reel assembly 20. The symbols on the stopped reels may be displayed relative to one or more pay lines printed on the display panel 32. The machine provides an award to the player if a combination of symbols along any active pay line is one of the winning outcomes defined by a pay table. Examples of physical reel slot games that may be conducted on the gaming machine 10 are disclosed in U.S. Pat. No. 6,203,429 to Demar et al., U.S. Pat. No. 6,190,255 to Thomas et al., U.S. Pat. No. 6,159,098 to Slomiany et al., and U.S. Pat. No. 6,004,207 to Wilson, Jr. et al., which are incorporated herein by reference in their entireties.

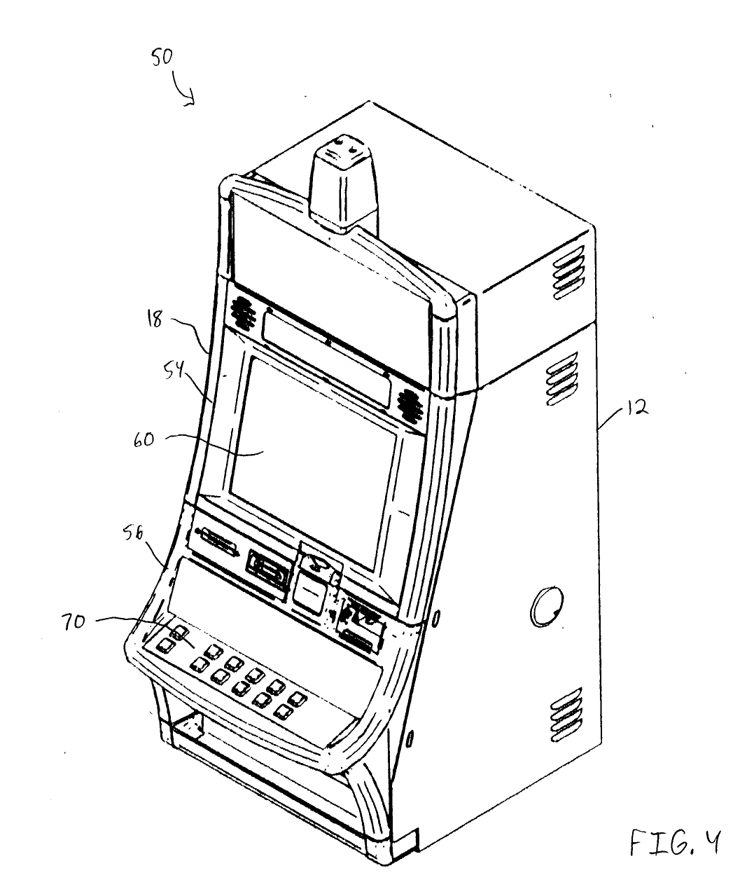

The game machine 10, which is used to conduct a physical reel slot game, may be converted to a gaming machine for conducting a video game such as video slots, poker, bingo, keno, or blackjack. FIG. 4 depicts a converted gaming machine 50 for conducting a video game. The machine 50 includes a cabinet 12 and a pair of front doors 54 and 56 hinged to the cabinet 12 along a generally vertical corner 18. The cabinet 12 and certain portions of the front doors 54 and 56 in FIG. 4 are the same as the cabinet 12 and certain portions of the front doors 14 and 16 in FIG. 1. The portions of the front doors that are modified when converting the gaming machine will be described below. In response to a wager for purchasing a play of the video game, the machine generates a random (or pseudo-random) event using a random number generator (RNG) and displays an outcome of the random event on a primary display device. The machine provides an award to the player if the outcome is one of the winning outcomes defined by a pay table. In the case of a video game, the primary display device for displaying the game outcome includes a video display 60. The video display 60 may, for example, be a cathode ray tube (CRT), liquid crystal display, plasma display, or other type of video display known in the art. In addition to the primary display device, the machine may include one or more secondary display devices for displaying other game features.

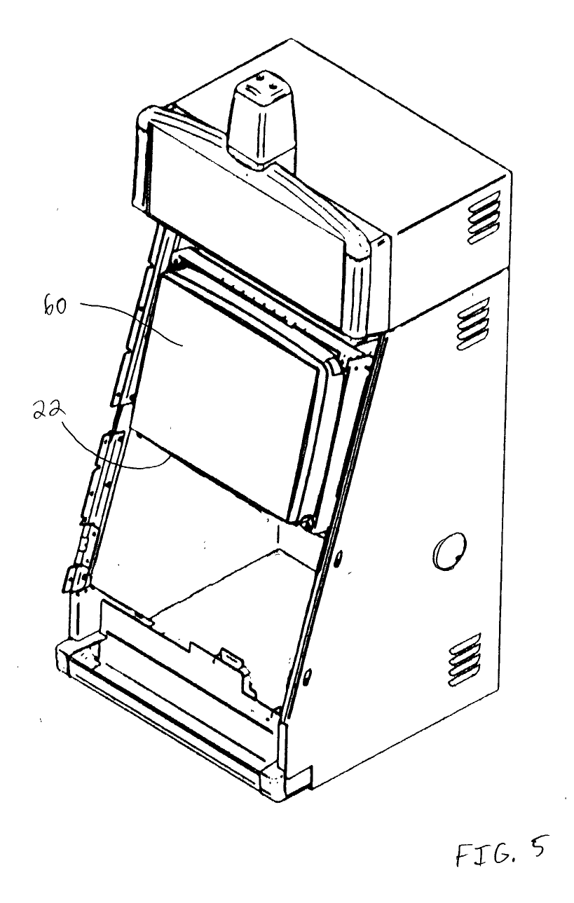

FIG. 5 depicts the gaming machine in FIG. 4 without its front doors to reveal an interior of the machine and, more specifically, the video display 60. The display shelf 22 supports the video display 60. To prevent the video display 60 from sliding during normal operation of the machine, the video display 60 is detachably engaged to the shelf 22 by screws, bolts, clips, or other fastening mechanisms.

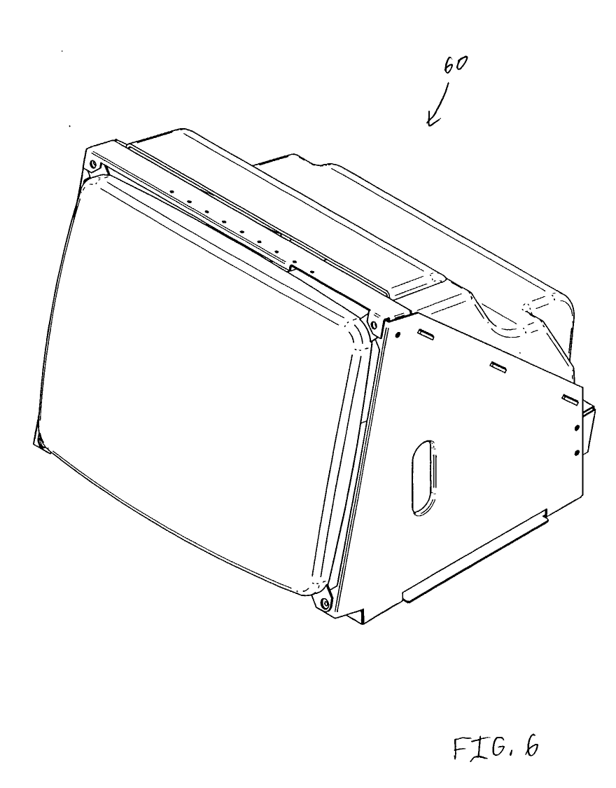

FIG. 6 depicts the video display 60. The video display 60 includes at least one interface board for controlling images on the display 60 based on instructions from the main control unit housed elsewhere in the gaming machine. The interface board is linked to the main control unit by appropriate electrical wiring. The video display 60 portrays game elements associated with the video game. The game elements may, for example, include graphical representations of slot reels (i.e., simulated slot reels), playing cards, keno boards, and bingo boards.

Referring back to FIG. 4, a player utilizes a user interface 70 (e.g., button panel) to operate the gaming machine. The user interface 70 may include a customized button configuration suitable for playing only a video game, or may alternatively include a generic button configuration suitable for playing either a reel slot game or a video game. The illustrated user interface 70 includes a customized button configuration different from the user interface 30 of the machine 10 in FIG. 1 and having twelve buttons: one line, three lines, five lines, seven lines, nine lines, bet one, bet two, bet three, bet four, bet five, collect, and change/call attendant. In response to a wager, the video display 60 portrays the game elements associated with the video game. The displayed game elements represent the game outcome. The machine provides an award to the player if the outcome is one of the winning outcomes defined by a pay table. Examples of video wagering games that may be conducted on the gaming machine 50 are disclosed in U.S. Pat. No. 6,364,766 to Anderson et al., U.S. Pat. No. 6,358,147 to Jaffe et al., U.S. Pat. No. 6,347,996 to Gilmore et al., and U.S. Pat. No. 6,270,411 to Gura et al., which are incorporated herein by reference in their entireties.

As the popularity of a wagering game wanes, a gaming establishment may wish to “refresh” the gaming machine used to conduct the wagering game so that it can conduct a new game. Also, manufacturers and suppliers may acquire used machines from gaming establishments and wish to convert a used machine so that it can conduct a new game. In either case, the present invention provides a method of converting between the gaming machine 10 in FIG. 1 (which conducts a physical reel slot game) and the gaming machine 50 in FIG. 4 (which conducts a video game). Because the present invention allows a gaming machine to be upgraded to different types of wagering games (i.e., physical reel slot games and video games), the present invention offers gaming establishments, manufacturers, and suppliers with greater flexibility in the manner in which gaming machines may be upgraded.

The preferred steps involved in converting the gaming machine 10 in FIG. 1 to the gaming machine 50 in FIG. 4 are described below.

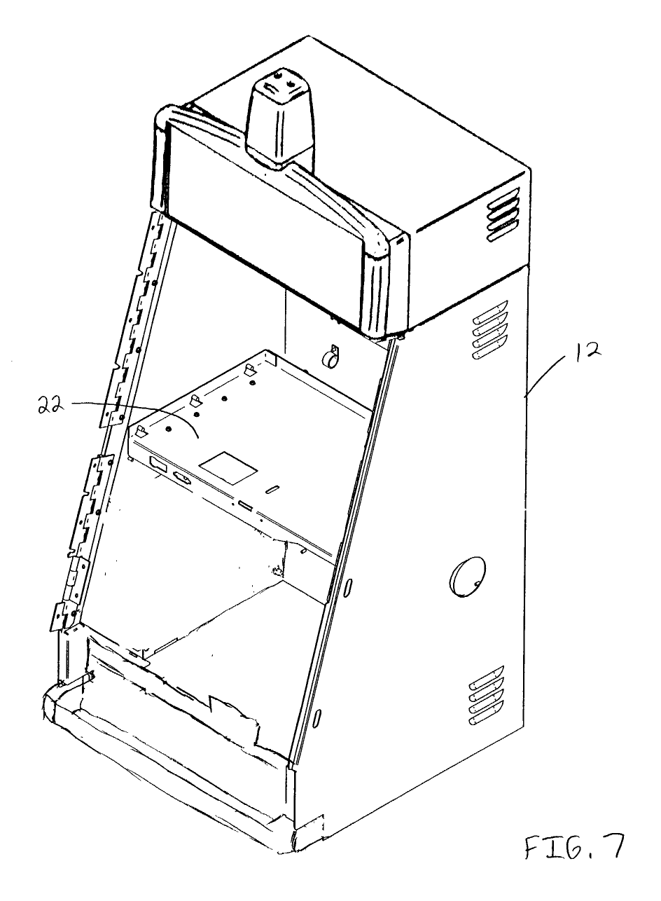

Referring to FIGS. 1 and 7, the upper and lower front doors 14 and 16 are unlocked and opened, and the gaming machine 10 is disconnected from power. The slot reel assembly 20 is unplugged from electrical wiring, detached from the shelf 22, and removed from the open cabinet 12. The slot arm handle 44 may be removed and replaced with a cover.

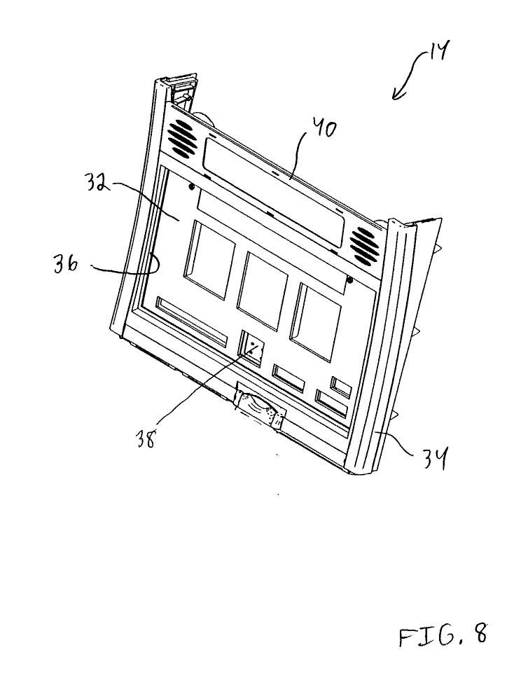

Referring to FIGS. 8 and 9, the upper front door 14 is disassembled. The upper front door 14 includes a U-shaped frame 34, a rectangular display panel bezel 36, the display panel 32, a display panel support frame 38, a speaker bar 40, and various mounting brackets 42 and fastening mechanisms for holding the foregoing components together. The support frame 38 may, in turn, include various display elements such as lamps, LEDs, vacuum-fluorescent displays, etc.

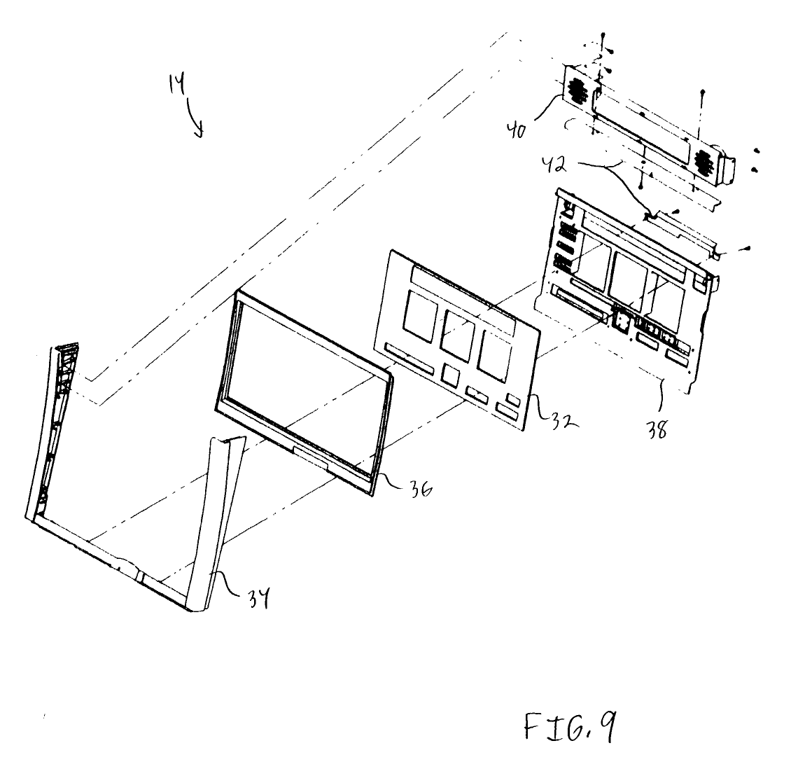

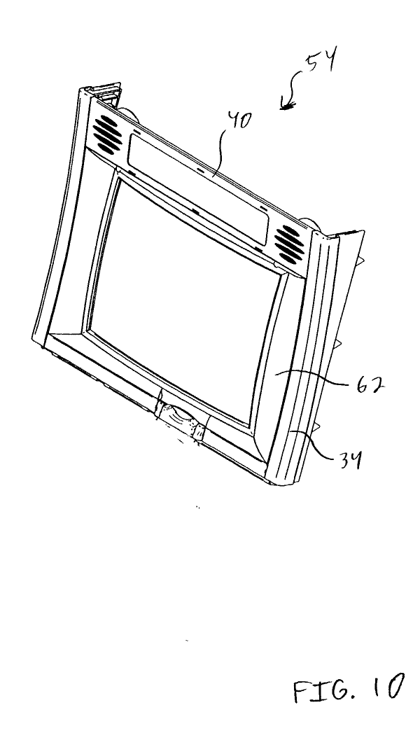

Referring to FIGS. 10 and 11, the disassembled upper front door is reassembled with modifications to become the front door 54 suitable for the gaming machine 50 in FIG. 4. The front door 54 includes the U-shaped frame 34, a rectangular video display bezel 62, the speaker bar 40, and various mounting brackets 64 and fastening mechanisms for holding the foregoing components together.

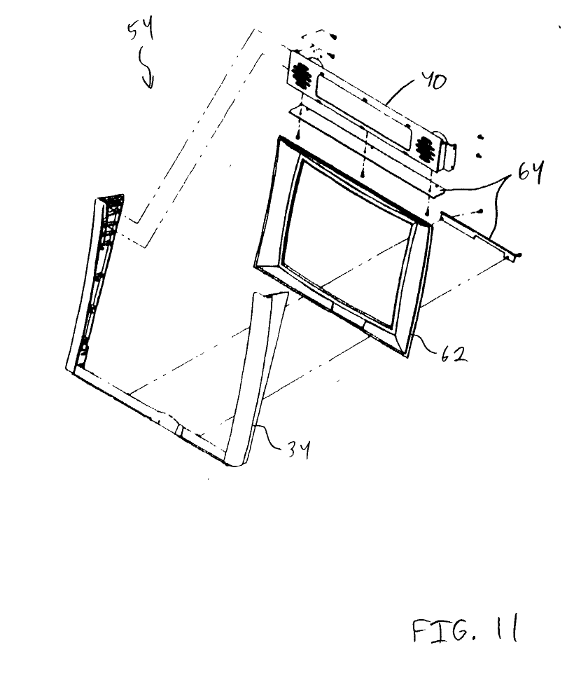

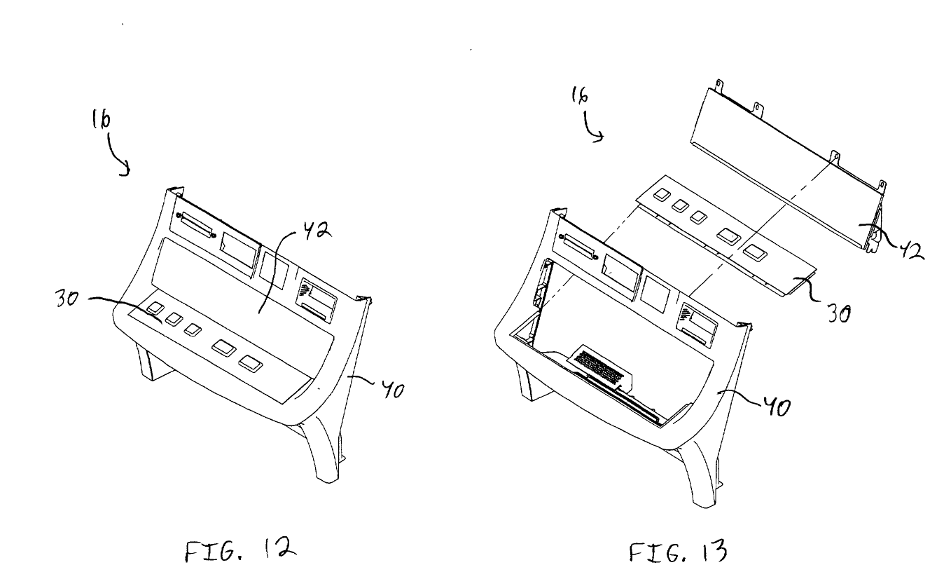

Referring to FIGS. 12 and 13, the lower front door 16 is disassembled. The lower front door 16 includes a frame 40, the user interface 30, and a glass frame assembly 42 that assists in retaining the user interface 30 in the frame 40. The glass frame assembly 42 is disconnected and removed from the frame 40, and then the user interface is unplugged from electrical wiring and slid out of the frame 40. Further information concerning assembly of the lower front door 16 may be obtained from U.S. patent application Ser. No. 10/201,833 entitled “Button Panel Assembly for a Gaming Machine,” filed Jul. 24, 2002, and incorporated herein by reference in its entirety.

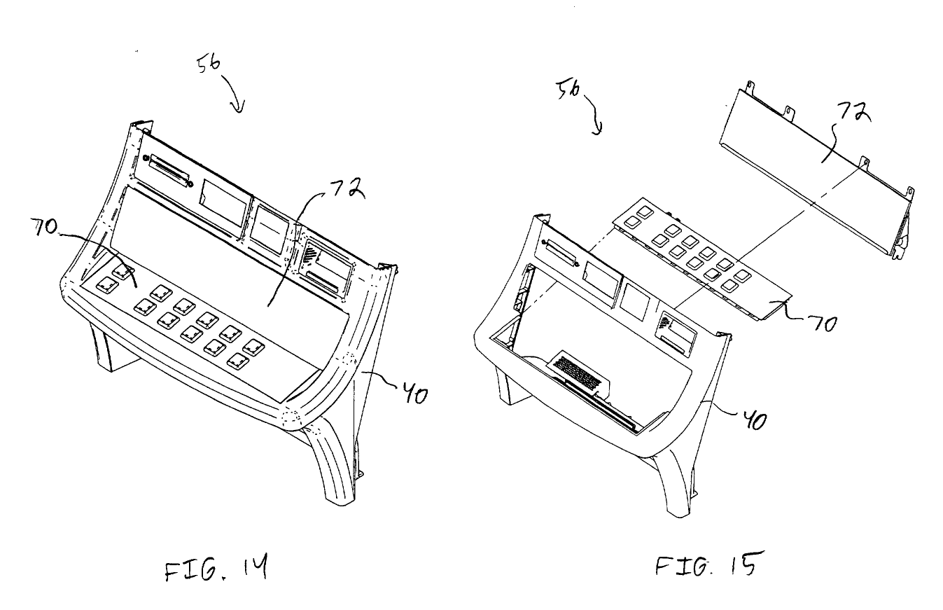

Referring to FIGS. 14 and 15, the disassembled lower front door is reassembled with modifications to become the front door 56 suitable for the gaming machine 50 in FIG. 4. The front door 56 includes the frame 40, the user interface 70, and a glass frame assembly 72. If the button configuration of the user interface 30 in FIGS. 12 and 13 was generic, i.e., suitable for both a reel slot game and a video game, the user interface 70 may be the same component as the user interface 30 in FIGS. 12 and 13. If, however, the button configuration of the user interface 30 in FIGS. 12 and 13 was customized, i.e., suitable for only a reel slot game, the user interface 70 is a new component replacing the user interface 30 in FIGS. 12 and 13. To assemble the front door 56, the user interface 70 is slid into the frame 40 and connected to electrical wiring, and then the glass frame assembly 72 is connected to the frame 40. The glass frame assembly 72 may include a different artwork panel than the glass frame assembly 42 in FIGS. 12 and 13, consistent with the theme of the new wagering game to be conducted on the converted gaming machine 50 in FIG. 4.

The upper and lower front doors may be disassembled and reassembled as described above while the frames 34 and 40 are still hinged to the cabinet 12. Alternatively, the front doors may first be detached (unhinged) from the cabinet 12, disassembled and reassembled as described above, and then re-attached to the cabinet 12.

Referring to FIGS. 4 and 7, the video display 60 is inserted into the cabinet, attached to the shelf 22, and linked to the main control unit housed elsewhere in the gaming machine 50. The main control unit is modified to include new game software for conducting a video wagering game that displays game outcomes on the video display 60. Depending upon whether the main control unit is programmed with multiple software drivers capable of controlling different types of display devices (e.g., the slot reel assembly 20 and the video display 60), the conversion method may require modifications to the main control unit so that it can control the video display 60. Similarly, depending upon whether the gaming machine is wired with universal cabling capable of connecting to different types of display devices (e.g., the slot reel assembly 20 and the video display 60), the conversion method may require modifications to the cabling so that the main control unit can connect to the video display 60. Furthermore, depending upon whether any other artwork (e.g., printed on glass, painted, decals, etc.) on the gaming machine is capable of supporting different types of wagering games, the conversion method may require modifications to the artwork so that the artwork is consistent with the wagering game to be conducted on the machine.

After applying power to the gaming machine 50 and testing the machine for proper operation, the conversion method is complete.

The method of converting the gaming machine 50 in FIG. 4 to the gaming machine 10 in FIG. 1 involves a reversal of the steps involved in converting the gaming machine 10 in FIG. 1 to the gaming machine 50 in FIG. 4.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims:

What is claimed is:

1. A method of converting a gaming machine between a reel spinning slot machine and a video gaming machine, the method comprising:
disengaging one of a physical slot reel assembly and a video display from a mounting mechanism in an interior of the gaming machine;
removing the one of the slot reel assembly and the video display from the interior of the gaming machine;
mounting the other of the slot reel assembly and the video display to the mounting mechanism in place of the removed one of the slot reel assembly and the video display.

2. The method of claim 1, further including:
opening a front door of the gaming machine prior to the removing step; and
closing the front door of the gaming machine after the installing step.

3. The method of claim 1, wherein the gaming machine includes a front door having one or more components associated with one of the slot reel assembly and the video display, and further including modifying the one or more components.

4. The method of claim 3, wherein the one or more components include a user interface.

5. The method of claim 3, wherein the one or more components include a display component for revealing one of the slot reel assembly and the video display.

6. The method of claim 1, wherein the removing step removes the slot reel assembly, and the installing step installs the video display in place of the removed slot reel assembly.

7. The method of claim 6, further including:
removing a first display component from a front door of the gaming machine, the first display component being for revealing the slot reel assembly; and
installing a second display component in place of the first display component, the second display component being for revealing the video display.

8. The method of claim 7, wherein the first display component includes a display panel with windows for viewing individual physical reels of the slot reel assembly, and wherein the second display component includes a bezel for encompassing a screen of the video display.

9. The method of claim 6, further including removing a slot arm handle mounted to a cabinet of the gaming machine.

10. The method of claim 1, wherein the removing step removes the video display, and the installing step installs the slot reel assembly in place of the removed video display.

11. The method of claim 10, further including:
removing a first display component from a front door of the gaming machine, the first display component being for revealing the video display; and
installing a second display component in place of the first display component, the second display component being for revealing the slot reel assembly.

12. The method of claim 11, wherein the first display component includes a bezel for encompassing a screen of the video display, and wherein the second display component includes a display panel with windows for viewing individual physical reels of the slot reel assembly.

13. The method of claim 1, wherein the gaming machine includes game software for portraying a wagering game with one of the slot reel assembly and the video display, and further including modifying the game software.

14. The method of claim 1, wherein the mounting mechanism is a display shelf.

15. A gaming machine convertible between a reel spinning slot machine and a video gaming machine, comprising:
a cabinet;
a mounting mechanism inside the cabinet; and
one of a physical slot reel assembly and a video display mounted to the mounting mechanism, each of the slot reel assembly and the video display being adapted to mount to the mounting mechanism;
wherein the gaming machine is adapted to permit removal of the one of the slot reel assembly and the video display from the cabinet and mounting of the other of the slot reel assembly and the video display to the mounting mechanism in place of the removed one of the slot reel assembly and the video display.

16. The machine of claim 15, further including a front door mounted to the cabinet, the front door having one or more components that are modified according to which of the slot reel assembly and the video display is mounted within the cabinet.

17. The machine of claim 16, wherein the one or more components include a user interface.

18. The machine of claim 16, wherein the one or more components include a display component for revealing one of the slot reel assembly and the video display.

19. The machine of claim 15, wherein the slot reel assembly is mounted to the mounting mechanism, and wherein the gaming machine is adapted to permit removal of the slot reel assembly from the cabinet and mounting of the video display to the mounting mechanism in place of the removed slot reel assembly.

20. The machine of claim 19, further including a front door mounted to the cabinet, the front door including a first display component for revealing the slot reel assembly, and wherein the gaming machine is adapted to permit removal of the first display component from the front door and installation of a second display component in place of the removed first display component, the second display component being for revealing the video display.

21. The machine of claim 20, wherein the first display component includes a display panel with windows for viewing individual physical reels of the slot reel assembly, and wherein the second display component includes a bezel for encompassing a screen of the video display.

22. The machine of claim 15, wherein the video display is mounted to the mounting mechanism, and wherein the gaming machine is adapted to permit removal of the video display from the cabinet and mounting of the slot reel assembly to the mounting mechanism in place of the removed video display.

23. The machine of claim 22, further including a front door mounted to the cabinet, the front door including a first display component for revealing the video display, and wherein the gaming machine is adapted to permit removal of the first display component from the front door and installation of a second display component in place of the removed first display component, the second display component being for revealing the slot reel assembly.

24. The machine of claim 23, wherein the first display component includes a bezel for encompassing a screen of the video display, and wherein the second display component includes a display panel with windows for viewing individual physical reels of the slot reel assembly.

25. The machine of claim 15, further including game software for portraying a wagering game with one of the slot reel assembly and the video display, the game software being modified according to which of the slot reel assembly and the video display is mounted within the cabinet.

26. The machine of claim 15, wherein the mounting mechanism is a display shelf.
